(19) United States
(12) Patent Application Publication
(10) Pub. No.: US 2026/0025878 A1
(43) Pub. Date: Jan. 22, 2026

(54) INITIATION FOR RADIO RESOURCE CONTROL CONNECTED STATE

(71) Applicant: Nokia Technologies Oy, Espoo (FI)

(72) Inventors: Ugur Baran ELMALI, Munich (DE); Malgorzata TOMALA, Wroclaw (PL); Guillaume DECARREAU, Munich (DE); Bernhard WEGMANN, Munich (DE); Jing HE, Beijing (CN); Malathi PONNIAH, Bangalore (IN)

(21) Appl. No.: 18/875,481

(22) PCT Filed: Aug. 9, 2022
(86) PCT No.: PCT/CN2022/111248

§ 371 Date: Dec. 16, 2024

(51) Int. Cl. H04W 76/27; H04W 24/08

(52) U.S. Cl. CPC H04W 76/27; H04W 24/08

(57) ABSTRACT

Embodiments of the present disclosure relate to devices, methods, apparatuses and computer readable storage media of the initiation for an RRC connected state. The method comprises receiving, from a second device, information related to a threshold value associated with a configuration of an application layer measurement performed by the first device: performing, during an RRC idle or inactive state, the application layer measurement based on the configuration; and in accordance with a determination that a measured value satisfies the threshold value, initiating a process for entering an RRC connected state. In this way, the UE may report the measurement by switching to the RRC connected state and meanwhile the transmission may be adjusted/optimized by the gNB without guiding the UE to the RRC connected state.

### FIELD

Embodiments of the present disclosure generally relate to the field of telecommunication and in particular to devices, methods, apparatuses, and computer readable storage media of an initiation for a Radio Resource Control (RRC) connected state.

### BACKGROUND

The 3rd Generation Partnership Project (3GPP) has studied New Radio (NR) application layer measurement (e.g., Quality of Experience (QoE)) management and optimizations for services, to identify a framework for collecting and reporting NR QoE measurements and to study the potential impact on the related Radio Access Network (RAN) interfaces.

### SUMMARY

In general, example embodiments of the present disclosure provide a solution of the initiation for an RRC connected state.

In a first aspect, there is provided a first device. The first device comprises at least one processor; and at least one memory storing instructions that, when executed by the at least one processor, cause the first device at least to receive, from a second device, information related to a threshold value associated with a configuration of an application layer measurement performed by the first device; perform, during an RRC idle or inactive state, the application layer measurement based on the configuration; and in accordance with a determination that a measured value satisfies the threshold value, initiate a process for entering an RRC connected state.

In a second aspect, there is provided a second device. The second device comprises at least one processor; and at least one memory storing instructions that, when executed by the at least one processor, cause the second device at least to generate information related to a threshold value associated with a configuration of an application layer measurement performed by a first device; and transmit information to the first device.

In a third aspect, there is provide a method. The method comprises receiving, from a second device, information related to a threshold value associated with a configuration of an application layer measurement performed by the first device; performing, during an RRC idle or inactive state, the application layer measurement based on the configuration; and in accordance with a determination that a measured value satisfies the threshold value, initiating a process for entering an RRC connected state.

In a fourth aspect, there is provide a method. The method comprises generating information related to a threshold value associated with a configuration of an application layer measurement performed by a first device; and transmitting information to the first device.

In a fifth aspect, there is provided an apparatus comprising means for receiving, from a second device, information related to a threshold value associated with a configuration of an application layer measurement performed by the first device; means for performing, during an RRC idle or inactive state, the application layer measurement based on the configuration; and means for, in accordance with a determination that a measured value satisfies the threshold value, initiating a process for entering an RRC connected state.

In a sixth aspect, there is provided an apparatus comprising means for generating information related to a threshold value associated with a configuration of an application layer measurement performed by a first device; and means for transmitting information to the first device.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of the initiation for an RRC connected state according to some example embodiments of the present disclosure;

FIG. 3 shows a flowchart of an example method of the initiation for an RRC connected state according to some example embodiments of the present disclosure;

FIG. 4 shows a flowchart of an example method of the initiation for an RRC connected state according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

### Example Environment

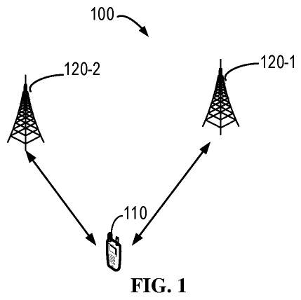

FIG. 1 shows an example communication network 100 in which embodiments of the present disclosure may be implemented. As shown in FIG. 1, the communication network 100 may include a terminal device 110. Hereinafter the terminal device 110 may also be referred to as a UE 110 or a first device 110.

The communication network 100 may further include network devices 120-1 and 120-2. Hereinafter the network device 120-1 may also be referred to as a gNB 120-1 or a second device 120, while the network device 120-2 may also be referred to as a gNB 120-2 or a third device 120-2. The network devices 120-1 and 120-2 may also be referred to as a network device 120 or a gNB 120 collectively.

The terminal device 110 may communicate with the network device 120-1 and the network device 120-2. For example, the serving cell the terminal device 110 may be managed by the network device 120-1 and the terminal device 110 may communicate with the network device 120-1 in an RRC connected state. Then the terminal device 110 may enter the RRC idle/inactive state. If the terminal device 110 intends to enter an RRC connected state, the terminal device 110 may initiate an RRCResumeRequest to the network device 120-1 or an RRCSetupRequest to the network device 120-2 if the serving cell of the terminal device 110 has been changed.

It is to be understood that the number of network devices and terminal devices shown in FIG. 1 is given for the purpose of illustration without suggesting any limitations. The communication network 100 may include any suitable number of network devices and terminal devices.

In some example embodiments, links from the network device 120 to the terminal device 110 may be referred to as a downlink (DL), while links from the terminal device 110 to the network device 120 may be referred to as an uplink (UL). In DL, the network device 120 is a transmitting (TX) device (or a transmitter) and the terminal device 110 is a receiving (RX) device (or receiver). In UL, the terminal device 110 is a TX device (or transmitter) and the network device 120 is a RX device (or a receiver).

Communications in the communication environment 100 may be implemented according to any proper communication protocol(s), includes, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, includes but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As described above, a framework for collecting and reporting NR application layer measurements (e.g., QoE measurements) has been studied and developed. An activation procedure of QoE measurement collection (QMC) may be used to initiate one or more QMC jobs at the UE. A “QoE reference ID” is used to uniquely identify one QMC job.

The NR QoE or the RAN-Visible (RV) QoE may be applied in an RRC connected state for supporting application layer measurement collection functionality. The scenario of applying NR QoE in an RRC idle/inactive state may still need to be discussed. For example, the NR QoE may be applied for in the RRC idle/inactive state to support the application layer measurement collection functionality for Multicast Broadcast Services (MBS) received in the RRC idle/inactive state.

The MBS may be used by the UEs in the RRC idle or inactive state while the QMC is activated. In a case where a UE enters the RRC idle or inactive state from the RRC connected state, the UE may be configured to perform the QoE measurements and/or RV-QoE measurements. However, the UE may not be able to report the result of QoE measurement to the network. Without the QoE measurement result, the network may perform the transmission only with a default pattern, for example, by using some pre-defined static parameters, and therefore Quality of Service (QOS) and/or QoE cannot be guaranteed for all UEs.

Therefore, it is desirable that the QoE measurement result is able to be reported to the network if the UE returns back to the RRC connected state. The specific RV-QoE included in the QoE measurement result may be used by RAN for adjusting the configurations of the MBS transmission.

### Work Principle and Example Signaling for Communication

According to some example embodiments of the present disclosure, there is provided a solution for the initiation for an RRC connected state. In this solution, the UE obtains a threshold value associated with an application layer measurement collection configuration, for example, a configuration of QMC and perform the corresponding measurement in an RRC idle/inactive state. If the UE determines that the measured value satisfies the threshold value, the UE initiates a process for entering the RRC connected state. In this way, the UE may report the measurement by switching to the RRC connected state and meanwhile the transmission may be adjusted/optimized by the gNB without guiding the UE to the RRC connected state.

Example embodiments of the present disclosure will be described in detail below with reference to the accompanying drawings.

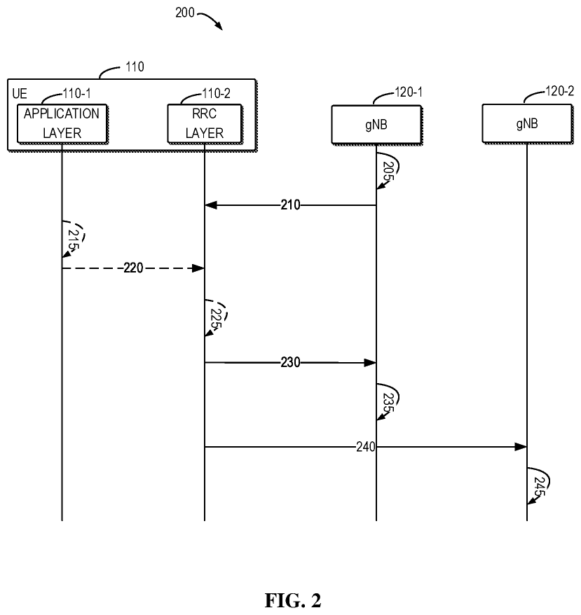

Reference is now made to FIG. 2, which shows a signaling chart 200 for communication according to some example embodiments of the present disclosure. As shown in FIG. 2, the signaling chart 200 involves a UE 110, a gNB 120-1 and a gNB 120-2. For the purpose of discussion, reference is made to FIG. 1 to describe the signaling chart 200. Although a single UE 110 is illustrated in FIG. 2, it would be appreciated that there may be a plurality of UEs performing similar operations as described with respect to the UE 110 below.

As shown in FIG. 2, in one example, the UE 110 may be served by the gNB 120-1 and in the RRC connected state. The gNB 120-1 may configure 205 a configuration of the application layer measurement collection for the UE 110. The application layer measurement collection used herein may be referred to as QMC and/or the like. The application layer measurement used herein may be referred to as one or more QoE measurements and/or one or more (RV)-QoE measurements. For example, the QMC configuration may be configured by the gNB 120-1 to command the UE 110 to perform RV-QoE measurements of MBS in the application layer.

The gNB 120-1 also configures respective threshold values for one or more QoE parameters/metrices in the application layer measurement collection. e.g., the QMC. For example, the one or more QoE parameters/metrices may comprise an application (e.g., video) buffer level, an average throughput, a playout delay, and/or the like.

Then the gNB 120-1 transmits 210 the configuration of the application layer measurement collection including the corresponding threshold(s) to the UE 110.

As an option, the gNB 120-1 may transmit the configuration along with the corresponding threshold(s) before the UE 110 enters the RRC idle/inactive state, for example, in a RRC release process or a RRC reconfiguration process.

As another option, the gNB 120-1 may also transmit the corresponding threshold(s) e.g., broadcasted via system information (SIB) or an MBS control channel, which may be referred to as MCCH in MBS framework. Providing the corresponding threshold(s) to the UE 110 in RRC idle/inactive state may allow the network side to adjust one or more thresholds associated with the application layer measurement, to achieve more flexibility at controlling the UE in RRC idle/inactive state. In some examples, it is also possible that the corresponding threshold(s) may also be transmitted from the gNB 120-2 to the UE 110, e.g., broadcasted via system information (SIB) or an MCCH.

When the UE 110 enters the RRC idle/inactive state, the UE 110 may perform the application layer measurement, for example, in the application layer 110-1 of the UE 110, based on the received configuration. The measurement result, for example, the QoE measurement report or the RV-QoE measurement report may be transmitted from the application layer 110-1 to the RRC layer 110-2 of the UE 110.

If no measured value of a parameter/metric associated with the application layer measurement satisfies the corresponding threshold value, the measurement result may be stored in the buffer of the UE 110. The UE 110 may report the measurement result to the serving gNB 120 at a proper occasion, for example, when the UE 110 returns to the RRC connected state. Furthermore, if no measured value of a parameter/metric associated with the application layer measurement satisfies the corresponding threshold value, the UE 110 may also continue performing the application layer measurement with a certain period.

If a measured value of a parameter/metric associated with the application layer measurement satisfies the corresponding threshold value, the UE 110 initiates a process for entering the RRC connected state.

It is to be understood that when the measured value satisfies a corresponding threshold value, the measured value exceeds a predetermined value or the measured value is lower than a predetermined value. It is also possible that the measured value satisfies a corresponding threshold value when the measured value equals a predetermined value.

As an option, the application layer 110-1 may determine 215 that the measured value satisfies the threshold value. The application layer 110-1 may transmit 220 an indication that the measured value satisfies the threshold value, to the RRC layer 110-2 e.g., via an Attention (AT) command.

As another option, the RRC layer 110-2 may determine 225 that the measured value satisfies the threshold value, for example, based on the measurement report transmitted from the application layer 110-1.

After determining that the measured value satisfies a corresponding threshold value, a request for entering the RRC connected state may be initiated from the UE 110 to a current camped gNB via a RRCSetupRequest, a RRCResumeRequest, RRCSetupRequestComplete or a RRCResumeRequestComplete. Alternatively or optionally, the request for entering the RRC connected state may include a cause for initiating the request, for example, an indication that a measured value of a parameter satisfies a corresponding threshold value. It is also possible that the request may also indicate more details such as the measured value, the corresponding value, a difference between the measured value and the corresponding value, and/or the like.

For example, if the gNB 120-1 still acts as the camped gNB of the UE 110, the UE 110 may transmit 230 a RRCResumeRequest to the gNB 120-1 for resuming the RRC connection between the UE 110 and the gNB 120-1. The gNB 120-1 may resume or establish 235 the RRC connection with the UE 110. The gNB 120-1 may also adjust MBS transmission parameters according to the request, for example, the cause for initiating the request and/or the further details of the cause.

If the camped gNB is changed, for example, switched to the gNB 120-2, similarly, the UE 110 may transmit 240 a RRCSetupRequest to the gNB 120-2 for establishing the RRC connection between the UE 110 and the gNB 120-2. The gNB 120-2 may establish 245 the RRC connection with the UE 11 and may also adjust MBS transmission parameters according to the request and the corresponding cause included in the request.

With the solution of the present disclosure, the UE may report the measurement by switching to the RRC connected state and meanwhile the transmission may be adjusted/optimized by the gNB without guiding the UE to the RRC connected state.

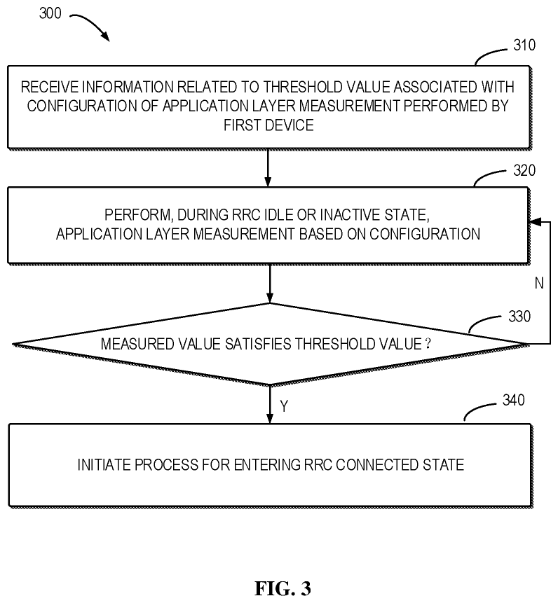

FIG. 3 shows a flowchart of an example method 300 of the initiation for an RRC connected state according to some example embodiments of the present disclosure. The method 300 may be implemented at the first device 110 as shown in FIG. 1. For the purpose of discussion, the method 300 will be described with reference to FIG. 1.

At 310, the first device 110 receives, from a second device, information related to a threshold value associated with a configuration of an application layer measurement performed by the first device.

In some example embodiments, the application layer measurement may comprise a QoE measurement or a RV QoE measurement.

In some example embodiments, the threshold value may be associated with at least one of a buffer level for an application, an average throughput, or a playout delay.

In some example embodiments, the first device may receive the information before the first device enters the RRC idle state or the RRC inactive state.

In some example embodiments, the first device may receive the information via an RRC release process or an RRC reconfiguration process.

In some example embodiments, the first device may receive the information via a system information block or a broadcast control channel signaling.

At 320, the first device performs, during an RRC idle or inactive state, the application layer measurement based on the configuration.

At 330, if the first device determines that a measured value satisfies the threshold value, at 340, the first device initiates a process for entering an RRC connected state.

In some example embodiments, if an RRC layer of the first device determines that the measured value satisfies the threshold value, the first device may cause a request for entering the RRC connected state to be transmitted by the first device.

In some example embodiments, if an application layer of the first device determines that the measured value satisfies the threshold value and an indication of the satisfaction is transmitted from the application layer to an RRC layer of the first device, the first device may cause a request for entering the RRC connected state to be transmitted by the first device.

In some example embodiments, the request may be transmitted to the second device for resuming the RRC connected state with the second device or to a third device for establishing the RRC connected state with the third device.

In some example embodiments, the request may comprise the indication that the measured value satisfies the threshold value.

In some example embodiments, if the UE 110, at 330, determines that no measured value satisfies the threshold value, the UE 110 may perform the application layer measurement, for example, similarly to that at 320.

In some example embodiments, the first device may comprise a terminal device and the second device may comprise a network device.

In some example embodiments, the third device may comprise a network device.

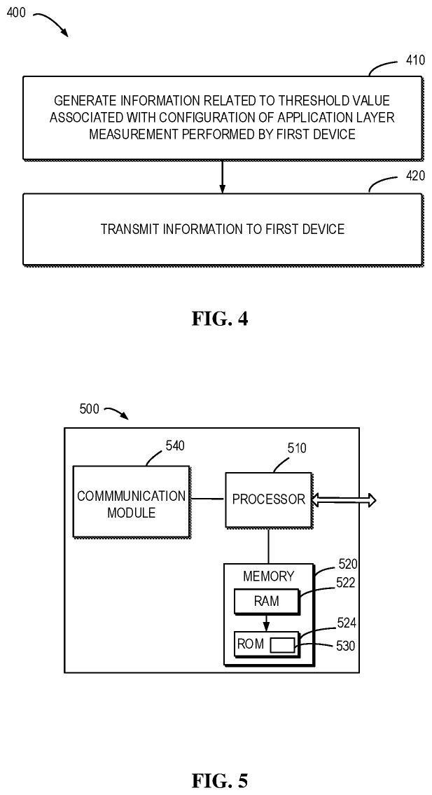

FIG. 4 shows a flowchart of an example method 400 of the initiation for an RRC connected state according to some example embodiments of the present disclosure. The method 400 may be implemented at the second device 120 as shown in FIG. 1. For the purpose of discussion, the method 400 will be described with reference to FIG. 1.

At 410, the second device generates information related to a threshold value associated with a configuration of an application layer measurement performed by a first device.

At 420, the second device transmits information to the first device.

In some example embodiments, the application layer measurement may comprise a QoE measurement or a RV QoE measurement.

In some example embodiments, the threshold value may be associated with at least one of a buffer level for an application, an average throughput, or a playout delay.

In some example embodiments, the second device may transmit the information before the first device enters an RRC idle state or an RRC inactive state.

In some example embodiments, the second device may transmit the information via an RRC release process or an RRC reconfiguration process.

In some example embodiments, the second device may transmit the information via a system information block or a multicast broadcast control channel.

In some example embodiments, if the second device determines that a request for entering an RRC connected state is received from the first device, the second device may resume the RRC connected state between the first and the second devices.

In some example embodiments, if the second device determines that the request indicates that the measured value satisfies the threshold value, adjust the threshold value or one or more transmission parameters, the second device may adjust the threshold value or one or more transmission parameters.

In some example embodiments, the first device comprises a terminal device and the second device comprises a network device.

### Example Apparatus, Device, and Medium

In some example embodiments, an apparatus capable of performing the method 300 (for example, implemented at the first device 110) may include means for performing the respective steps of the method 300. The means may be implemented in any suitable form. For example, the means may be implemented in a circuitry or software module.

In some example embodiments, the apparatus comprises means for receiving, from a second device, information related to a threshold value associated with a configuration of an application layer measurement performed by the first device; means for performing, during an RRC idle or inactive state, the application layer measurement based on the configuration; and means for, in accordance with a determination that a measured value satisfies the threshold value, initiating a process for entering an RRC connected state.

In some example embodiments, the application layer measurement may comprise a QoE measurement or a RV QoE measurement.

In some example embodiments, the threshold value may be associated with at least one of a buffer level for an application, an average throughput or a playout delay.

In some example embodiments, the means for receiving the information may further comprise means for receiving the information before the first device enters the RRC idle state or the RRC inactive state.

In some example embodiments, the means for receiving the information may further comprise means for receiving the information via an RRC release process or an RRC reconfiguration process.

In some example embodiments, the means for receiving the information may further comprise means for receiving the information via a system information block or a broadcast control channel signaling.

In some example embodiments, the means for initiating the process of entering the RRC connected state may further comprise means for, in accordance with a determination that an RRC layer of the first device determines that the measured value satisfies the threshold value, causing a request for entering the RRC connected state to be transmitted by the first device.

In some example embodiments, the means for initiating the process of entering the RRC connected state may further comprise means for, in accordance with a determination that an application layer of the first device determines that the measured value satisfies the threshold value and an indication of the satisfaction is transmitted from the application layer to an RRC layer of the first device, causing a request for entering the RRC connected state to be transmitted by the first device.

In some example embodiments, the request may comprise the indication that the measured value satisfies the threshold value.

In some example embodiments, the apparatus may further comprise means for, in accordance with a determination that no measured value satisfies the threshold value, performing the application layer measurement.

In some example embodiments, the first device may comprise a terminal device and the second device may comprise a network device.

In some example embodiments, the third device may comprise a network device.

In some example embodiments, an apparatus capable of performing the method 400 (for example, implemented at the second device 120) may include means for performing the respective steps of the method 400. The means may be implemented in any suitable form. For example, the means may be implemented in a circuitry or software module.

In some example embodiments, the apparatus comprises means for generating information related to a threshold value associated with a configuration of an application layer measurement performed by a first device; and means for transmitting information to the first device.

In some example embodiments, the application layer measurement may comprise a QoE measurement or a RV QoE measurement.

In some example embodiments, the threshold value may be associated with at least one of a buffer level for an application, an average throughput or a playout delay.

In some example embodiments, the means for transmitting the information may further comprise means for transmitting the information before the first device enters an RRC idle state or an RRC inactive state.

In some example embodiments, the means for transmitting the information may further comprise means for transmitting the information via an RRC release process or an RRC reconfiguration process.

In some example embodiments, the means for transmitting the information may further comprise means for transmitting the information via a system information block or a multicast broadcast control channel.

In some example embodiments, the apparatus may further comprise means for, in accordance with a determination that a request for entering an RRC connected state is received from the first device, resuming the RRC connected state between the first and the second devices.

In some example embodiments, the apparatus may further comprise means for, in accordance with a determination that the request indicates that the measured value satisfies the threshold value, adjusting the threshold value or one or more transmission parameters.

In some example embodiments, the first device comprises a terminal device and the second device comprises a network device.

FIG. 5 is a simplified block diagram of a device 500 that is suitable for implementing example embodiments of the present disclosure. The device 500 may be provided to implement a communication device, for example, the terminal device 110 or the network device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The instructions of the program 530 may include instructions for performing operations/acts of some example embodiments of the present disclosure. The program 530 may be stored in the memory, e.g., the ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIG. 2 to FIG. 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. In some example embodiments, the computer readable medium may include any types of non-transitory storage medium, such as ROM, EPROM, a flash memory, a hard disk. CD, DVD, and the like. The term “non-transitory,” as used herein, is a limitation of the medium itself (i.e., tangible, not a signal) as opposed to a limitation on data storage persistency (e.g., RAM vs. ROM).

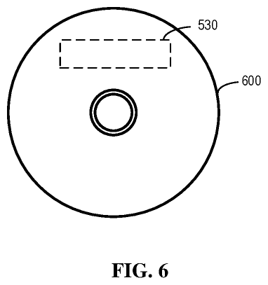

FIG. 6 shows an example of the computer readable medium 600 which may be in form of CD, DVD or other optical storage disk. The computer readable medium 800 has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provides at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to:
receive, from a second device, information related to a threshold value associated with a configuration of an application layer measurement performed by the first device;
perform, during a Radio Resource Control, RRC, idle or inactive state, the application layer measurement based on the configuration; and
in accordance with a determination that a measured value satisfies the threshold value, initiate a process for entering an RRC connected state.

2. The first device of claim 1, wherein the application layer measurement comprises a Quality of Experience, QoE, measurement or a radio access network visible QoE measurement.

3. The first device of claim 1, wherein the threshold value is associated with at least one of the following:
a buffer level for an application of the first device,
an average throughput, or
a playout delay.

4. The first device of claim 1, wherein the first device is caused to receive the information before the first device enters the RRC idle state or the RRC inactive state.

5. The first device of claim 1, wherein the first device is caused to receive the information via an RRC release process or an RRC reconfiguration process.

6. The first device of claim 1, where the first device is caused to receive the information via a system information block or a broadcast control channel signaling.

7. The first device of claim 1, wherein the first device is caused to:
in accordance with a determination that an RRC layer of the first device determines that the measured value satisfies the threshold value, cause a request for entering the RRC connected state to be transmitted by the first device.

8. The first device of claim 1, wherein the first device is caused to:
in accordance with a determination that an application layer of the first device determines that the measured value satisfies the threshold value and an indication of the satisfaction is transmitted from the application layer to an RRC layer of the first device, cause a request for entering the RRC connected state to be transmitted by the first device.

9. The first device of claim 7, wherein the request is transmitted to one of:
the second device for resuming the RRC connected state with the second device, or
a third device for establishing the RRC connected state with the third device.

10. The first device of claim 7, wherein the request comprises the indication that the measured value satisfies the threshold value.

11. The first device of claim 1, wherein the first device comprises a terminal device and the second device comprises a network device.

12. The first device of claim 9, wherein the third device comprises a network device.

13. A second device comprising:
at least one processor; and
at least one memory storing instructions that, when executed by the at least one processor, cause the second device at least to:
generate information related to a threshold value associated with a configuration of an application layer measurement performed by a first device; and
transmit information to the first device.

14. The second device of claim 13, wherein the application layer measurement comprises a Quality of Experience, QoE, measurement or a radio access network visible QoE measurement.

15. The second device of claim 13, wherein the threshold value is associated with at least one of the following:
a buffer level for an application of the first device,
an average throughput, or
a playout delay.

16. The second device of claim 13, wherein the second device is caused to transmit the information before the first device enters an RRC idle state or an RRC inactive state.

17. The second device of claim 13, wherein the second device is caused to transmit the information via an RRC release process or an RRC reconfiguration process.

18. The second device claim 13, where the second device is caused to transmit the information via a system information block or a multicast broadcast control channel.

19. The second device of claim 13, wherein the second device is caused to:
in accordance with a determination that a request for entering an RRC connected state is received from the first device, resume the RRC connected state between the first and the second devices.

20. The second device of claim 19, wherein the second device is caused to:
in accordance with a determination that the request indicates that the measured value satisfies the threshold value, adjust the threshold value or one or more transmission parameters.

21. The second device of claim 13, wherein the first device comprises a terminal device and the second device comprises a network device.

22. A method comprising:
receiving, at a first device and from a second device, information related to a threshold value associated with a configuration of an application layer measurement performed by the first device;
perform, during a Radio Resource Control, RRC, idle or inactive state, the application layer measurement based on the configuration; and
in accordance with a determination that a measured value satisfies the threshold value, initiate a process for entering an RRC connected state.

23-33. (canceled)

34. A method comprising:
generating, at a second device, information related to a threshold value associated with a configuration of an application layer measurement performed by a first device; and
transmitting information to the first device.

35-46. (canceled)
